(19) United States
(12) Patent Application Publication
(10) Pub. No.: US 2017/0111294 A1
(43) Pub. Date: Apr. 20, 2017

(54) INTEGRATED FOLDED CLOS ARCHITECTURE

(71) Applicant: Compass Electro Optical Systems Ltd., Netanya (IL)

(72) Inventors: Michael LAOR, Zichron Yaakov (IL); David ZELIG, Zichron Yaakov (IL)

(21) Appl. No.: 14/885,156

(22) Filed: Oct. 16, 2015

(51) Int. Cl. H04L 12/933

(52) U.S. Cl. CPC H04L 49/101

(57) ABSTRACT

An improved integrated Clos network may include a plurality of servers, each server comprising a processor and a network interface chip, and a plurality of cross bar switches, each cross bar switch having a direct connection to each network interface chip such that a data packet can be transferred between any two servers by means of any cross bar switch. Each network interface chip can be configured to receive a data packet directly from memory associated with the processor comprising the same server as the network interface chip, read and process the data packet in order to produce a processed data packet configured to be routed from the network interface chip via a cross bar switch to a network interface chip associated with a different server, select a cross bar switch, and transmit the processed data packet to the selected cross bar switch.

### FIELD OF THE INVENTION

The present invention relates to router and switch architecture in general and, in particular, to optimizations of a folded Clos network architecture configuration.

### BACKGROUND

A common topology of connecting data center elements is a folded Clos network. A folded Clos network allows connecting multiple elements in an efficient and non-blocking way. A typical implementation is shown in FIG. 1 and described further below. Each server is a leaf and is connected, typically using Ethernet, to a port of the leaf switch. The leaf switch is connected to several servers and as well has up link connections to spine switches which are located one level above in the switching hierarchy. The leaf switch can switch information simultaneously between any pair of its ports and as well support multicast from one to many. The spine switch is connected to each of the leaf switches and like the leaf switch can switch information between any pair of its ports simultaneously.

A known property of a Clos network is that the number of leaf and spine switches is determined by the total number of devices which are to be connected to the system. The number of spine switches is determined by the number of ports on each of the leaf switches that are destined for spine connectivity, since each leaf switch should connect to all the spine switches. Conversely, the number of leaf switches is determined by the total number of servers or other devices that are to be connected to the network, divided by the number of such devices that can be handled by a single leaf switch.

When a server communicates with another server, it sends a packet to the leaf switch via its network interface adaptor (such as an Ethernet MAC device). The leaf switch, using the routing address at the header of the packet (this can be any of Ethernet, MPLS or IP address or any other type of address), determines the destination and sends the packet either to a server that is directly connected to it, or to a spine switch if the packet is destined to a server that is connected to a different leaf switch. There are known techniques in Clos network architecture to carry out load balancing among spine switches by alternating between them using one of several known algorithms.

FIG. 1 illustrates a folded Clos network 100 for the interconnection of a plurality of servers 102. As shown, each leaf switch 112a, 112b, . . . through 112n connects a plurality of servers (represented by ′, ″, and ′″ for each switch 112a-n) into the network 100. The leaf switches 112a-n are each connected to spine switches 122a-n which route signals between leaf switches in order to facilitate communication between servers. For example, a signal originating at server 102a″ intended for server 102b′″ could first be sent from the origin 102a″ to the leaf switch 112a, then to a spine switch 122a, to the leaf switch 112b, and finally to the destination server 102b′″. Various arrangements of elements in which multiple servers are served by a single leaf switch are known with respect to folded Clos switch architecture.

A disadvantage of the traditional folded Clos network is that the multiple tiers of switches external to the servers introduces additional processing times and resource costs in the system. By accommodating multiple servers each, the leaf switches reduce the number of connections required for each spine switch to a level that matches the technological limitations of the prior art, but at the same time they introduce another layer of processing, decoding, and routing into the network.

A need therefore exists for a streamlined Clos architecture which reduces latency by streamlining the components necessary to provide full connectivity between servers on a network.

### SUMMARY

An improved Clos network architecture is described in which separate leaf switches are eliminated from the system, their functionality instead performed by integrated components of each server. Integrated network interface chips are introduced which can receive data packets directly from the server CPU memory, process and frame the data as necessary, and communicate directly with spine switches on the network. This results in a more adaptive network with fewer components and reduced latency.

According to one aspect, the present disclosure is directed at an integrated Clos network comprising a plurality of servers, each server comprising a processor and a network interface chip. The integrated Clos network can also comprise a plurality of cross bar switches, each cross bar switch having a direct connection to each network interface chip such that a data packet can be transferred between any two servers by means of any cross bar switch. Each network interface chip can be configured to receive a data packet directly from memory associated with the processor comprising the same server as the network interface chip, read and process the data packet in order to produce a processed data packet configured to be routed from the network interface chip via a cross bar switch to a network interface chip associated with a different server, select a cross bar switch, and transmit the processed data packet to the selected cross bar switch.

In some embodiments, the direct connections between the network interfaces and the cross bar switches can be optical connections.

According to another aspect, the present disclosure is directed to an integrated Clos network comprising a plurality of servers, each server comprising a processor and a network interface chip. The integrated Clos network can also comprise a plurality of cross bar switches, each cross bar switch having a direct connection to each network interface chip such that a data packet can be transferred between any two servers by means of any cross bar switch. Each network interface chip can be configured to receive a data packet directly from memory associated with the processor comprising the same server as the network interface chip, read and process the data packet in order to produce a plurality of processed data fragments configured to be routed from the network interface chip via a cross bar switch to a network interface chip associated with a different server, and for each processed data fragment, select a cross bar switch and transmit the processed data fragment to the selected cross bar switch

In some embodiments, for each of the processed data fragments, the selected cross bar switch can be configured to receive the processed data fragment and transmit the processed data fragment to the network chip for which the fragment is configured to be routed. The network interface chip can also be configured to receive a plurality of the processed data fragments and assemble them into a processed data packet.

While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 illustrates a configuration for a typical folding Clos architecture.

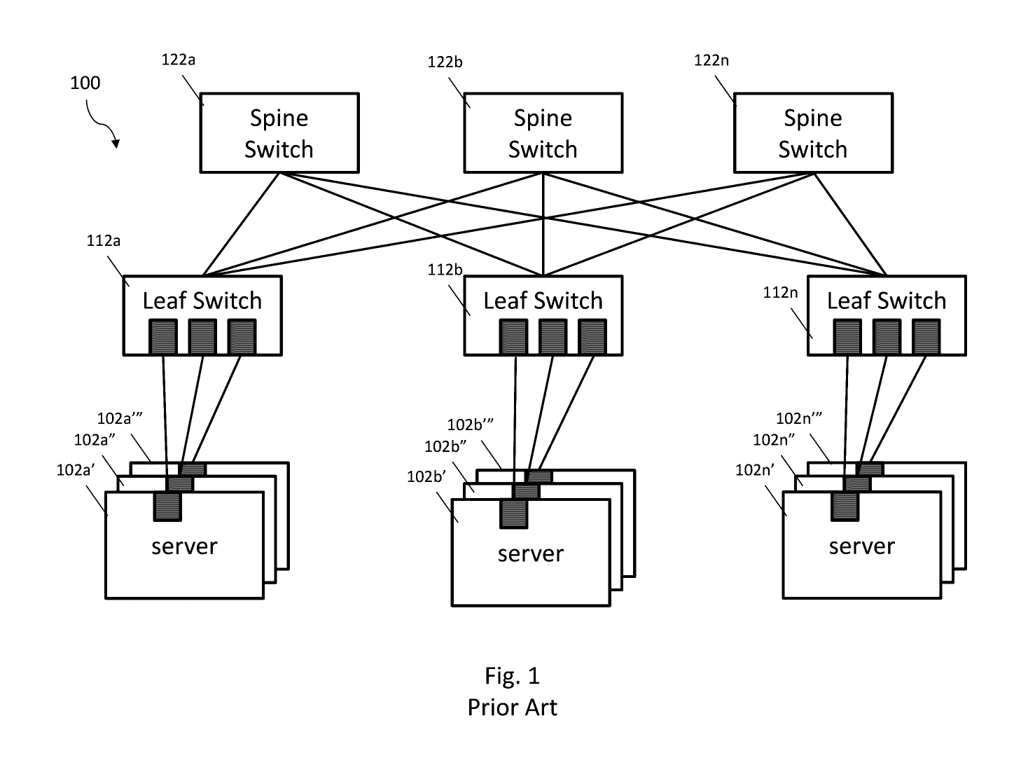

FIG. 2 illustrates an integrated Clos architecture in accordance with embodiments of the present invention.

FIG. 3 illustrates an integrated Clos architecture in accordance with embodiments of the present invention.

FIG. 4 is two flowcharts illustrating a method of routing a packet using a typical folding Clos architecture, comparing this method to the reduced steps needed with an integrated Clos architecture.

FIG. 5 illustrates a further integrated network architecture in accordance with embodiments of the present invention.

### DETAILED DESCRIPTION

In an improved network arrangement, described as an integrated folded Clos network, a component of the server subsumes, for each server, the portion of the functions of the leaf switch normally left to that particular server. Logically the leaf switch in a common folded Clos configuration provides switching services to all the servers that are connected to it. In the integrated folded Clos, the leaf switch function is partitioned such that each server houses the components which perform the switching services for that server. The improved architecture, in combining the leaf and the leaf switch into a single layer, significantly reduces the latency and complexity of the network.

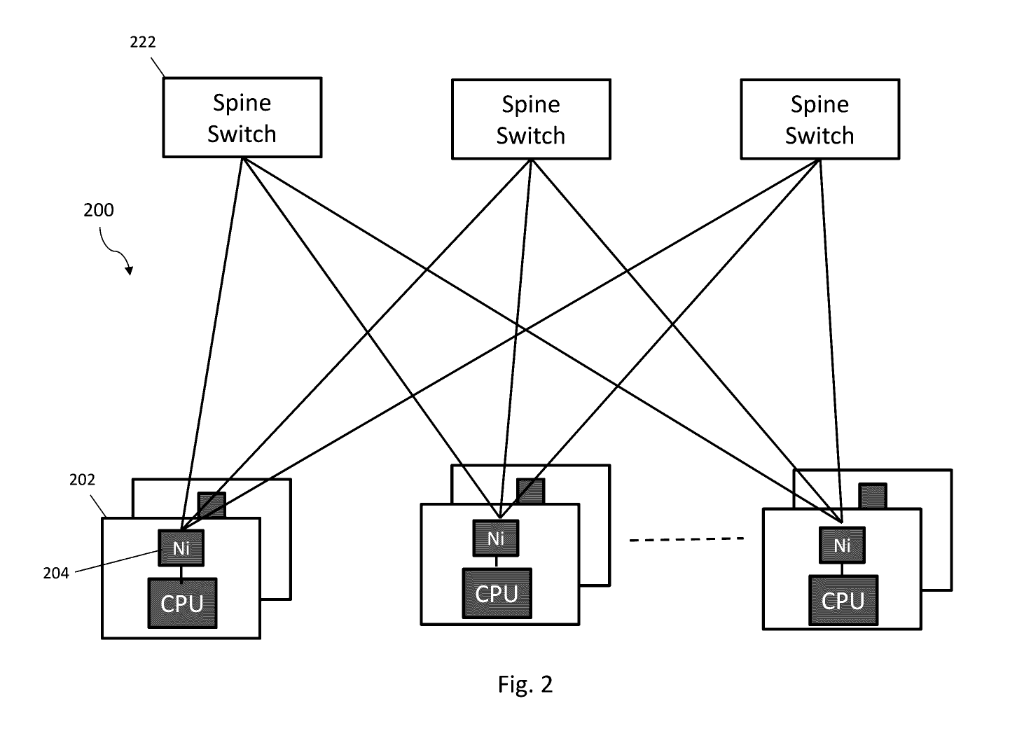

An improved network architecture is shown in FIG. 2 illustrating an integrated folded Clos system 200. Here, each server 202 includes a network interface (NI) chip 204 which performs Clos leaf functions associated with its particular server 202.

Each NI chip performs a variety of functions that would normally be allocated to the leaf switch. For example, the NI chip provides the regular media adaption function (e.g. media encapsulation and termination for any protocols that are used by the network). Furthermore, the NI chips 204 each also provide the routing functions between their particular server and the rest of the Clos network.

Each NI chip 204 is directly connected to all the spine switches 222. When the local server's CPU needs to communicate with another server, it sends a packet to the local Network Interface chip. The NI chip 204 identifies the priority and destination and then encapsulates the packet using the media layer protocol (which may be, for example, the Ethernet frame format) and an additional internal header that is used by the spine switches and the target NI chip. It then selects a particular spine switch 222 based on some appropriate algorithm and sends the packet to the selected spine switch 222. The process by which the NI chip selects a particular spine switch may be based on another of factors and may take into account load balancing algorithms known in the art for Clos networks and other network configurations. In some implementations, the packet may be fragmented into smaller cells and re-ordered at the destination NI chip in order to achieve low latency and efficient load balancing across the system.

The spine switch, when it receives the packet, performs switching in the regular way it operates in any folded Clos network. It then sends the packet (or the specific fragment) to the destination server. When the packet arrives at the NI chip on the destination server, it is de-capsulated from the media header. In some implementations, the receiving NI chip may evaluate the priority of the packet and, if necessary, sort it in any existing packet queue before or after packets of differing priority. If the packet is fragmented at the source NI chip, the NI chip performs reassembly of the fragments into packets. If the application requires in-order delivery of packets, the receiving NI chip may re-order the received packets (based on, for example, a sequence number stamp) before sending to the local host. The packet will then be sent from the NI chip to the processor of the destination server. In some implementations, in order to reduce latency between the receiving NI chip and the processor, one or more other steps usually performed by the destination processor upon receiving a packet can instead be performed by the NI chip before it sends the packet.

Integrated leaf Clos network in accordance with the present invention should ideally include a direct connection between each NI chip on an included server and each spine switch in the Clos network. Because the number of servers on the network may be large, and the numerous servers may be physically located at a considerable distance from each other, accommodating this configuration is a considerable technological challenge.

Fortunately, the Applicant's advancements in optical and opto-electronic interconnect technologies provide solutions to these challenges. In some implementations, each NI chip may include a direct optical connection to each spine switch, and each spine switch may include an opto-electronic IO interconnect chip, as described in Applicant's U.S. Pat. No. 7,702,191, granted on Apr. 20, 2010, and U.S. patent application Ser. No. 13/543,347, filed Jul. 6, 2012, each of which is herein incorporated by reference as though included in its entirety.

Applicant's optical and electro-optical interconnects allow a large number of fibers to be directly attached to the silicon of the spine switch. Packets can thus be received and sent to and from NI chips as optical signals while still being evaluated electronically as necessary. The large number of fibers connected to the Spine switch silicon allow it to connect to a large number of servers.

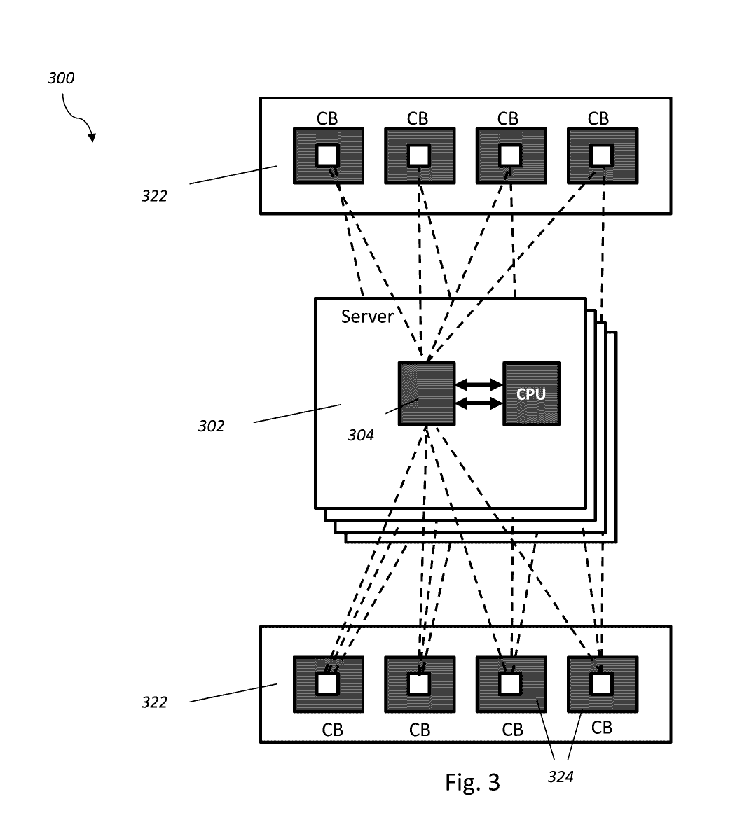

Another configuration for an integrated Clos network 300 is shown in FIG. 3, in which spine switches 322 are illustrated each having multiple cross bar chips 324 each which direct fibers attached to it. As shown, each server 302 includes an NI chip 304 as described above, and each NI chip 304 includes connections to multiple cross bar chips 324, each of which can independently perform the functions of a spine switch. Multiple spine switches 322, each including a set of cross bar chips 324, can allow for additional redundancy as multiple paths exist between each pair of servers even within a single switch 322.

In some implementations, the NI and circuit board (CB) switching elements may be implemented by standard Ethernet switch devices. However, in other implementations, the network can use an integrated approach where there are internal protocols and framing within the CB and NI communication which allows efficient load balancing and granular flow control that allows efficient scheduling of packets across the fabric (for example, using VOQ and other techniques to prevent cross-traffic issues such as head-of-line blocking).

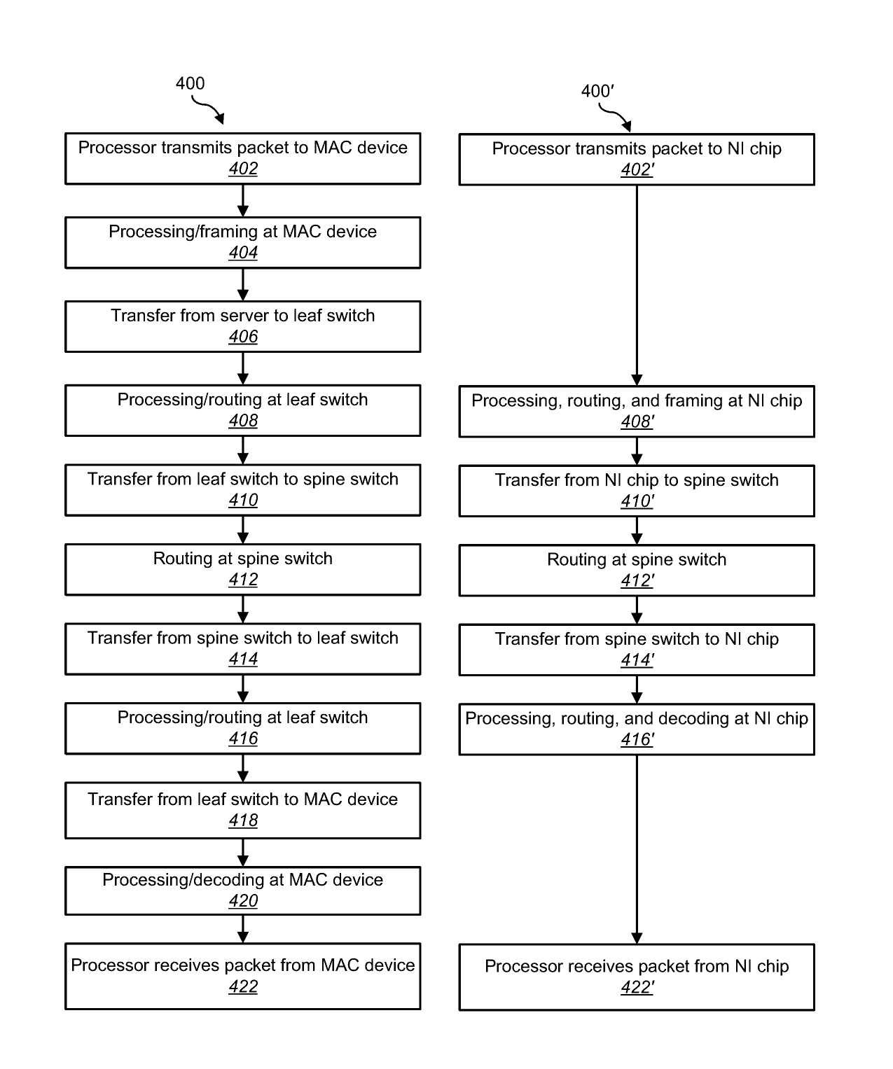

In some implementations, the direct interface between the NI device and the processor (which could be, for example, a standard PCIe interface), allows the NI device to read the packet directly from the CPU memory when it is scheduled for transmission. FIG. 4 illustrates the difference between a typical prior art process 400 and an improved process 400′ according to the present invention. Prior art approaches typically involve first delivering and processing each packet at an Ethernet MAC device (402). The MAC device processes the packet and packages it for Ethernet framing (404) before transmitting the packet to the leaf switch (406) where it is again processed for routing and further transmittal (408). By allowing direct access to the processor without the need for the intermediate MAC device, a further reduction in latency and increase in memory resource efficiency is realized. The NI chip receives the packet directly from the CPU memory (402′) and performs the various processing, routing, and framing steps only one time rather than two (408′). The Clos routing steps are the same in both processes (412 and 414 versus 412′ and 414′), but again the receiving NI chip combines the processing, routing, and decoding processes that usually occur separately between the leaf switch and the server (416, 418, 420, and 422 versus 416 and 422). The elimination of these resource consuming steps is one of the advantages of the integrated network according to the present disclosure over a conventional Clos network.

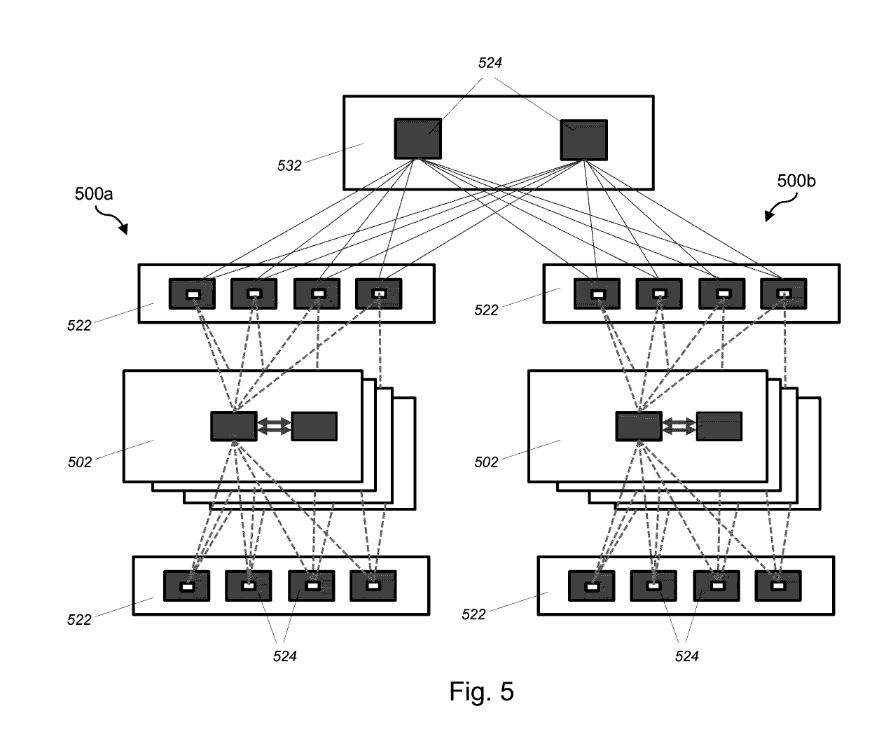

Note that if more servers are required, another switching level can be added above the spine switching level, as demonstrated in FIG. 5. Two networks 500a and 500b as described above are interconnected by means of a second-level switch 532. Each of the two networks 500 include a plurality of servers 502 as above interconnected by cross bar chips 524 disposed on spine switches 522, and then additional cross bar chips 534 interconnect with the cross bar chips 524 on the spine switches 522 to provide communication between the servers 502 on the first network 500a and the servers 502 on the second network 500b.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. For example, potentially any network architecture could benefit from the techniques disclosed herein. Thus, such other embodiments and modifications are intended to fall within the scope of the present disclosure. As another example, some of the functionality that in the embodiments described above is embodied by the NI chips (such as routing decisions or packet fragmentation and defragmentation) may be instead implemented by the CPU of a server associated with the routing architecture.

Further, although the present disclosure has been presented herein in the context of at least one particular implementation in at least one particular environment for at least one particular purpose, those of ordinary skill in the art will recognize that its usefulness is not limited thereto and that the present disclosure can be beneficially implemented in any number of environments for any number of purposes. Accordingly, the claims set forth below should be construed in view of the full breadth and spirit of the present disclosure as described herein.

What is claimed is:

1. An integrated Clos network comprising:
a plurality of servers, each server comprising a processor and a network interface chip; and
a plurality of cross bar switches, each cross bar switch having a direct connection to each network interface chip such that a data packet can be transferred between any two servers by means of any cross bar switch;
wherein each network interface chip is configured to:
receive a data packet directly from memory associated with the processor comprising the same server as the network interface chip,
read and process the data packet in order to produce a processed data packet configured to be routed from the network interface chip via a cross bar switch to a network interface chip associated with a different server,
select a cross bar switch, and
transmit the processed data packet to the selected cross bar switch.

2. The network of claim 1,
wherein the direct connections between the network interfaces and the cross bar switches are optical connections.

3. An integrated Clos network comprising:
a plurality of servers, each server comprising a processor and a network interface chip;
a plurality of cross bar switches, each cross bar switch having a direct connection to each network interface chip such that a data packet can be transferred between any two servers by means of any cross bar switch;
wherein each network interface chip is configured to:
receive a data packet directly from memory associated with the processor comprising the same server as the network interface chip,
read and process the data packet in order to produce a plurality of processed data fragments configured to be routed from the network interface chip via a cross bar switch to a network interface chip associated with a different server, and
for each processed data fragment, select a cross bar switch and transmit the processed data fragment to the selected cross bar switch.

4. The network of claim 3,
wherein, for each of the processed data fragments, the selected cross bar switch is configured to receive the processed data fragment and transmit the processed data fragment to the network chip for which the fragment is configured to be routed; and
wherein a network interface chip is configured to receive a plurality of the processed data fragments and assemble them into a processed data packet.

5. The network of claim 3,
wherein the direct connections between the network interfaces and the cross bar switches are optical connections.
